(19) United States
(12) Patent Application Publication
(10) Pub. No.: US 2006/0129425 A1
(43) Pub. Date: Jun. 15, 2006

(54) Method of curbing health-care costs

(76) Inventor: Anuthep Benja-Athon, New York, NY (US)

Correspondence Address: ANUTHEP BENJA-ATHON, M.D.;Pain Management, Acupuncture Physical Therapy, 210 E 36th St., New York, NY, 10016, US

(21) Appl. No.: 11/010,922

(22) Filed: Dec. 14, 2004

(51) Int. Cl. G06Q 10/00; G06Q 40/00; G06F 9/44

(52) U.S. Cl. 705/2; 705/39; 705/7

(57) ABSTRACT

A method of curbing the health-care costs comprises processes wherein physicians use digital speech recording devices and speech recognition softwares to reduce the business costs, curtailing wasted time and interferences and hassles impose on the physicians and health-care consumers and buyers while increasing their productivity and returns. The method also causes the physicians and health-care consumers and buyers to exert controls on their works, productivity, earnings and health-care funds and expenses.

### FIELD OF INVENTION

The method of reducing the health-care costs.

### BACKGROUND OF THE INVENTION

A pending application Ser. No. 10/950,315 entitled a Method of Empowering Consumers-Controlled Health-Care filed Sep. 27, 2004, a pending application Ser. No. 10/760,694 entitled a method of Modulating Health-Care expenses filed Jan. 21, 2004, a pending application Ser. No. 10/328,993 entitled the Best American Healthcare System filed Dec. 26, 2002, and an abandoned application Ser. No. 10/298,100 entitled the Best Healthcare System filed Nov. 18, 2002 and U.S. Pat. No. 6,132,218 entitled Images for Communication of Medical Information in Computer was granted to this applicant on Oct. 17, 2000 represent our continual quests to solve the current health-care crisis.

As recently as Dec. 2, 2004, a national publication reported that the American health-care costs and expenses “continue to increase at unmanageable levels for employers and consumers”. All attempts, efforts and health-care systems have failed to heretofore curb the escalating health-care costs. There are more uninsured Americans than ever. In other words, the solution for curbing the increase in the health-care costs and expenses was not heretofore found. Consequently, the adverse health and economic consequences affecting this nation are obvious.

This patent application, together with said pending applications, provides the only means for effectively curbing and reducing the escalating health-care costs and expenses of this nation and improve people's health, quality of life and standard of living.

### SUMMARY OF THE INVENTION

The solution to the current health-care crisis was not heretofore attainable by any and all prior art means, methods and systems as the health-care costs continue to rise and health-care becomes less affordable.

The present invention is the only method of reducing health-care costs. It comprises processes wherein physicians use digital speech recording devices and speech recognition softwares to reduce the business and operating costs, curtailing wasted time and interferences and hassles impose on the physicians and health-care consumers and buyers while increasing their productivity and returns. Through said processes, the present invention causes the physicians and health-care consumers and buyers to exert controls on their works, productivity, earnings and health-care funds and expenses.

### DESCRIPTION OF THE PREFERRED EMBODIMENTS

The present invention is a method of curbing and/or reducing the escalating health-care costs and expenses of health-care consumers and buyers such as people, companies, corporations and/or government.

The method provides a process of enhancing or maximizing the productivity of the physicians who are facilitated by the present invention. Moreover, the method provides the processes of reducing or minimizing the costs of operating the business or the costs of running the offices of the physicians.

The method provides the process wherein the physicians use the digital voice or speech recording devices for storing and transmitting information on patients. Said digital devices comprise any digital voice or speech recording devices such as, but not limited to, computers, laptop configurations, portable digital voice or speech recorders and the like. Said devices including the accessories may be attached to cords, wireless or any combination thereof. These devices use various digital speech standards and formats. Said devices use several commercial speech recognition softwares manufactured by various corporations such as, but not limited to, the International Business Machines, Inc. A common commercial speech recognition software is the Dragon Naturally Speaking versions (ScanSoft, Inc.) and the like. The information from said digital devices can be interfaced with machines so that said information can be stored and transmitted.

The method provides a process wherein the physicians of same medical specialty dictate and input specific formats or templates of information or files of specific information relating to a particular medical specialty into said digital voice or speech recording devices for repetitive recalls and uses.

The method provides a process wherein the physicians use a process of dictating and inputting patients' information at any and all stages of contacts with any and all patients into said digital voice or speech recording devices. Almost all papers, if not all, pertaining to said task are eliminated.

The method provides a process of merging any said format, formats, template, templates, file or files with any and all patients' information.

The method provides a process of reducing the losses of time by physicians comprises a process wherein the physicians use digital voice or speech recording devices including digital voice or speech recorders according to the scheme supra and infra. As a result, first, the method provides a process of eliminating the third parties such as insurance companies and third-party payers which interfere, impede and obstruct with the practice and delivery of health-care by physicians and increase said costs to all. Therefore, the interferences, hassles and nuisances being imposed by said companies and payers are eliminated by the method.

Just in the above arena alone, the present invention results in savings in terms of American physicians' productivity of about 140 billion dollars per annum or about 10% of the current health-care expenses of 1.5 trillion dollars per annum. This percentage is a result of an extremely conservative estimate by this applicant. The above figure is derived from this applicant's estimation based on the fact that there are about 600,000 American physicians almost all of whom are probably spending about 2 or more hours per day doing all types of paper-works to fulfill the insurance companies' and other third-parties' demands. If the calculation is derived by using only 500,000 physicians, the calculation leads to more than 365 million physician hours per annum—currently being lost or wasted annually to said choirs—that may be saved by said processes of the present invention. A reasonable and conservative estimate of $300 per hour is used for the above computation. A lot, if not all, of Americans including the uninsured can be well cared for by the above precious resources.

Said processes of the present invention not only increase and improve the physicians' productivity, quality of work and livelihood, satisfaction and self-esteem and the reduction of stresses, it also produces same in patients, employers, companies, corporations and government. It further wrings out billions of dollars per annum of inefficiency, wastes and useless treatments. Certainly, that amounts to hundreds of billions of dollars per annum.

Second, said digital information can be safeguarded by electronic security such as, but not limited to, the use of HTML, XTML, Portable Document Format (Adobe Systems, Inc.), electronic locks and the like.

The present invention provides a process of reducing the losses of time by physicians comprises a process wherein the physicians, using the above processes, effect the electronic payments and disbursements of funds to the physicians subsequent to the physicians dictations and inputs of patients' information into digital voice or speech recording devices including digital voice or speech recorders. As a result, therefore, first, the method provides a process that eliminates third parties such as, but not limited to, the insurance companies and other third-party payers which interfere, impede and obstruct payments or disbursements—or very often refuse to pay for the physicians' performed health-care services—to said physicians resulting in the increases of said costs and loss of revenues. Therefore, the interferences, hassles and nuisances being imposed by said companies and payers are eliminated by the processes of the present invention which reduce or eliminate said companies and third-party payers.

Furthermore, the present invention also provides a process of reducing the losses of time by the physicians by effecting the electronic transactions of electronic payments and disbursements derived from the funds own and oversee by patients, companies and/or corporations to the physicians subsequent to said processes. Said processes not only increase and improve the physicians' productivity but also generate immense savings for physicians, patients, employers, companies, corporations and government.

Furthermore, the present invention causes the physicians, people, companies, corporations, government to exert controls of the health-care consumptions and expenses. Furthermore, the above processes cause the people, companies, corporations, government to exert their controls and authority of ownership of their health-care dollars or funds. These are achieved by the above processes by curtailing the hassles impose on the physicians and patients as the above processes effect the electronically transacting electronic payments and disbursements derived from said funds own and oversee by patients, companies and/or corporations to the physicians subsequent to said processes wherein the physicians dictating and inputting patients' information into digital voice or speech recording devices including digital voice or speech recorders. A protocol is created to link individual electronic payments to corresponding physicians' works.

Therefore, the present invention provides said processes yielding better returns for the physicians for their time expended and works performed on patients and for patients, companies, corporations, government for their health-care funds or expenses.

Although the preferred embodiments have been described, it will be appreciated by those skilled in art that variations, adaptations and applications of the present invention can be had without departing from the spirit of the invention and the scope of the claims.

1. A method of curbing escalating health-care costs of people, companies, corporations and government comprises:
a process of reducing the physicians' costs of business operations;
a process of reducing the losses of time by the physicians;
a process of curtailing the hassles impose on the physicians;
a process of electronically effecting electronic payments being derived from the funds own and oversee by patients, companies and/or corporations to compensate the physicians;
a process of electronically transacting electronic payments being derived from the funds own and oversee by patients, companies and/or corporations to compensate the physicians;
a process of electronically transacting electronic disbursements of electronic payments being derived from the funds own and oversee by patients, companies and/or corporations to compensate the physicians; and
a process linking individual electronic payments to corresponding physicians' works.

2. The method of curbing the escalating health-care costs according to claim 1 wherein said process of reducing the physicians' costs of business operations comprises a process wherein the physicians use digital speech recording devices including digital speech recorders.

3. The method of curbing the escalating health-care costs according to claim 1 wherein said process of reducing the physicians' costs of business operations comprises a process wherein the physicians use a process of dictating and inputting formats or templates of information relating to medicine into digital speech recording devices including digital speech recorders.

4. The method of curbing the escalating health-care costs according to claim 1 wherein said process of reducing the physicians' costs of business operations comprises a process wherein the physicians use a process of dictating and inputting patients' information into digital speech recording devices including digital speech recorders.

5. The method of curbing the escalating health-care costs according to claim 1 wherein said process of reducing the physicians' costs of business operations comprises a process of merging a format, formats, template or templates of information relating to medicine with patients' information.

6. The method of curbing the escalating health-care costs according to claim 1 wherein said process of reducing the physicians' costs of business comprises physicians merge a format, formats, template or templates of information relating to medicine with patients' information in digital speech recording device including digital speech recorders.

7. The method of curbing the escalating health-care costs according to claim 1 wherein said process of reducing the physicians' costs of business operations comprises a process wherein physicians dictate and input a format, formats, template or templates of information relating to medicine and a patient's information into digital speech recording devices including digital speech recorders.

8. The method of curbing the escalating health-care costs according to claim 1 wherein said process of reducing the losses of time by physicians comprises a process wherein the physicians use digital speech recording devices including digital speech recorders.

9. The method of curbing the escalating health-care costs according to claim 1 wherein said process of reducing the losses of time by the physicians comprises a process of curbing third parties' interferences wherein the physicians dictate and input patients' information into digital speech recording devices including digital speech recorders.

10. The method of curbing the escalating health-care costs according to claim 1 wherein said process of reducing the losses of time by the physicians comprises a process of using electronic payments and disbursements of finds to the physicians subsequent to the physicians dictating and inputting patients' information into digital speech recording devices including digital speech recorders.

11. The method of curbing the escalating health-care costs according to claim 1 wherein said process of reducing the losses of time by the physicians comprises a process of electronically transacting electronic payments and disbursements being derived from the funds own and oversee by patients, companies and/or corporations to the physicians subsequent to a process wherein the physicians dictating and inputting patients' information into digital speech recording devices including digital speech recorders.

12. The method of curbing the escalating health-care costs according to claim 1 wherein said process of curtailing the hassles impose on the physicians comprises a process wherein the physicians dictate and input patients' information into digital speech recording devices including digital speech recorders.

13. The method of curbing the escalating health-care costs according to claim 1 wherein said process of curtailing the hassles impose on the physicians comprises a process of electronically transacting electronic payments and disbursements derived from the funds own and oversee by patients, companies and/or corporations to the physicians subsequent to a process wherein the physicians dictate and input patients' information into digital speech recording devices including digital speech recorders.

14. The method of curbing the escalating health-care costs according to claim 1 wherein said process linking individual electronic payments to corresponding physicians' works comprises a process of using a protocol relating individual electronic payments to corresponding outcomes of a process wherein the physicians dictate and input patients' information into digital speech recording devices including digital speech recorders.

15. The method of curbing the escalating health-care costs according to claim 1 wherein said process linking individual electronic payments to corresponding physicians' works comprises a process of using a payment and compensation scheme relating individual electronic payments to corresponding individual outcomes of a process wherein the physicians dictate and input patients' information into digital speech recording devices including digital speech recorders.

16. A method of exerting control on the health-care expenses of and costs to people, companies, corporations, government by physicians and the exertions of the authority of ownership of said people, companies, corporations, government of their health-care dollars or funds comprises:
a process of reducing the physicians' costs of business operations;
a process of reducing the losses of time by the physicians;
a process of curtailing the hassles impose on the physicians;
a process of electronically effecting electronic payments being derived from the funds own and oversee by patients, companies and/or corporations to compensate the physicians;
a process of electronically transacting electronic payments being derived from the funds own and oversee by patients, companies and/or corporations to compensate the physicians;
a process of electronically transacting electronic disbursements of electronic payments being derived from the funds own and oversee by patients, companies and/or corporations to compensate the physicians; and
a process linking individual electronic payments to corresponding physicians' works.

17. A method of yielding better returns for the physicians for their time expended and works performed on patients and for health-care consumers and health-care buyers for their health-care funds and expenses comprises:
a process of reducing the physicians' costs of business operations;
a process of reducing the losses of time by the physicians;
a process of curtailing the hassles impose on the physicians;
a process of electronically effecting electronic payments being derived from the funds own and oversee by patients, companies and/or corporations to compensate the physicians;
a process of electronically transacting electronic payments being derived from the funds own and oversee by patients, companies and/or corporations to compensate the physicians;
a process of electronically transacting electronic disbursements of electronic payments being derived from the funds own and oversee by patients, companies and/or corporations to compensate the physicians; and
a process linking individual electronic payments to corresponding physicians' works.
